(19) United States
(12) Patent Application Publication
(10) Pub. No.: US 2015/0120025 A1
(43) Pub. Date: Apr. 30, 2015

(54) SYSTEM AND METHOD FOR CREATING A DYNAMIC ACTIVITY PROFILE

(71) Applicant: JayBird LLC, Salt Lake City, UT (US)

(72) Inventors: BEN WISBEY, Canberra (AU); DAVID SHEPHERD, Canberra (AU)

(73) Assignee: JAYBIRD LLC, Salt Lake City, UT (US)

(21) Appl. No.: 14/568,835

(22) Filed: Dec. 12, 2014

Related U.S. Application Data
(63) Continuation-in-part of application No. 14/140,414, filed on Dec. 24, 2013.
Application No. 14/140,414 is a continuation-in-part of application No. 14/137,942, filed on Dec. 20, 2013.
Application No. 14/137,942 is a continuation-in-part of application No. 14/137,734, filed on Dec. 20, 2013.
Application No. 14/137,734 is a continuation-in-part of application No. 14/062,815, filed on Oct. 24, 2013.

(51) Int. Cl. G06F 19/00

(52) U.S. Cl. CPC G06F 19/3481
USPC 700/91

(57) ABSTRACT

A system for creating and dynamically updating a user activity profile includes a processor, a sensor module, and a memory module. The memory module includes stored computer program code that, along with the memory module and the processor, is configured to carry out a number of operations to create and dynamically update the user activity profile. One such operation involves maintaining an activity archive that includes activity information received from the sensor module and that is representative of a user's activity. Another such operation includes creating and updating a dynamic activity profile based on initial user input and further based on the activity archive. The initial user input contributes to the dynamic activity profile according to a first weighting factor, and the activity archive contributes to the dynamic profile according to a second weighting factor.

### CROSS-REFERENCE TO RELATED APPLICATIONS

This application is a continuation-in-part of and claims the benefit of U.S. patent application Ser. No. 14/140,414, filed Dec. 24, 2013, titled “System and Method for Providing an Intelligent Goal Recommendation for Activity Level”; which is a continuation-in-part of U.S. patent application Ser. No. 14/137,942, filed Dec. 20, 2013, titled “System and Method for Providing an Interpreted Recovery Score”; which is a continuation-in-part of U.S. patent application Ser. No. 14/137,734, filed Dec. 20, 2013, titled “System and Method for Providing a Smart Activity Score”; which is a continuation-in-part of U.S. patent application Ser. No. 14/062,815, filed Oct. 24, 2013, titled “Wristband with Removable Activity Monitoring Device.” The contents of the Ser. No. 14/140,414 application, the Ser. No. 14/137,942 application, the Ser. No. 14/137,734 application, and the Ser. No. 14/062,815 application, are incorporated herein by reference in their entireties.

### TECHNICAL FIELD

The present disclosure relates generally to activity monitoring devices, and more particularly to systems and methods for creating a dynamic activity profile for a user based on the user's monitored activity.

### BACKGROUND

Conventional activity monitoring and lifestyle/fitness tracking devices generally enable only a recommendation of activity that accounts for desired calories burned, steps taken—in other words, the tracked metrics are static, and do not adjust based on a user's actual behavior. Thus, one issue with conventional devices is that they do not learn a user's tendencies regarding activity, such as trends in the user's activity levels. Moreover, existing devices do not robustly track or capture the user's activity to include, for example, sleep activity or fatigue or recovery levels of the user. Another issue is that currently available solutions do not recommend activity levels based on an analysis of changes and trends in a user's activity profile—as such, conventional activity monitoring and fitness/lifestyle devices do not have the capability of recommending personalized, yet achievable goals for the user. Nor do conventional activity monitoring and fitness/lifestyle devices have the capability of recommending activity based on a learned, dynamic activity profile for the user. Additionally, conventional solutions lack the ability to provide activity recommendations based on an integration of a learned activity profile for a user with scheduled events and/or training load models.

### BRIEF SUMMARY OF THE DISCLOSURE

In view of the above drawbacks, there exists a long-felt need for an activity monitoring and fitness/lifestyle device and system that tracks user activity levels and analyzes and responds to multifaceted inputs regarding the user's activity. Further, there is a need for fitness monitoring/lifestyle devices that embody such systems to dynamically update a user activity profile and provide personalized, yet realistic goals for the user's activity levels based on ongoing trends and changes in the user activity profile. Activity goals and recommendations for a user may be more effective when the goals are finely tuned to the user's in flux capabilities and physiology. Such finely tuned goals may be generated based on the disclosed systems and methods for creating a dynamic user activity profile that tracks, analyzes, and integrates robust information about the user.

Embodiments of the present disclosure provide systems, methods, and apparatus for creating a dynamic user activity profile that tracks user activity according to multifaceted data points, and analyzes those data points to effectively learn the user's tendencies regarding activity. Moreover, by tracking robust datasets for a user, and by the analysis disclosed herein, the dynamic activity profile may be finely tuned to the user's in flux capabilities and physiology, such that personalized, yet realistic goals and activity recommendations may be provided to the user.

According to one embodiment of the disclosure, an apparatus for creating and dynamically updating a user activity profile includes an initial activity profile module, a sensor module, an activity archive module, and a dynamic activity profile module. The initial activity profile module creates an activity profile for a user. The sensor module monitors the user's activity to generate activity information. The activity archive module maintains an activity archive that includes the activity information. The activity information may include one or more of heart rate variability data, activity level data, sleep data, subjective feedback data, activity level data, and training load data. The dynamic activity profile module updates the activity profile based on the activity archive. In one example implementation, the initial activity profile module, the sensor module, the activity archive module, and the dynamic activity profile module are embodied in a wearable device.

According to another embodiment, the apparatus includes an activity recommendation module that provides a recommendation related to the user's activity and based on the activity profile. The apparatus, in one instance, includes a profile accuracy module that provides an indication of an estimated level of accuracy of the activity profile. The estimated level of accuracy is based on an amount and a consistency of the activity information.

Another aspect of the present disclosure involves a method for creating and dynamically updating a user activity profile. The method includes creating an activity profile for a user, tracking the user's activity, and creating and updating a dynamic activity profile based on the activity profile and the user's activity. The method also includes, in one example implementation, creating and updating an activity archive based on the user's activity.

Creating the activity profile may include modifying the user input according to normative statistical data. Tracking the user's activity, in one instance, includes monitoring a movement of the user using a wearable device. In another instance, tracking the user's activity includes determining an activity level of the user. And, in such an instance, the dynamic activity profile is based on one or more of an average of the user's activity level, a range of the user's activity level, and a skew of the user's activity level. Tracking the user's activity may also include tracking a set of activity parameters and providing an activity recommendation based on one or more of the activity parameters. The set of activity parameters, in one example implementation of the disclosure, includes heart rate variability, sleep duration, sleep quality, subjective feedback from the user, previous activity levels, and training load data.

In one embodiment, the activity profile contributes to the dynamic activity profile according to a first weighting factor, and the user's activity contributes to the dynamic activity profile according to a second weighting factor. Such an embodiment may also involve decreasing the first weighting factor as information about the user's activity is tracked and stored in the activity archive, and increasing the second weighting factor as information about the user's activity is tracked and stored in the activity archive. The method may, in one case, also include receiving user input to an activity questionnaire. In such a case, the activity profile is based on the user input to the activity questionnaire.

An additional aspect of the present disclosure includes a system for creating and dynamically updating a user activity profile. The system includes a processor, a sensor module, and a memory module. The memory module includes stored computer program code. The memory module, the stored computer program code, and the processor are configured to maintain an activity archive that includes activity information received from the sensor module and that is representative of a user's activity. Additionally, the memory module, the stored computer program code, and the processor are configured to create and update a dynamic activity profile based on initial user input and further based on the activity archive. The initial user input contributes to the dynamic activity profile according to a first weighting factor, and the activity archive contributes to the dynamic profile according to a second weighting factor.

In one embodiment of the system, the memory module, the stored computer program code, and the processor are further configured to vary the first and second weighting factors based on the activity information maintained in the activity archive. The memory module, the stored computer program code, and the processor may be further configured to recommend activities for the user based on the dynamic activity profile. In one example implementation of the system, the processor, the sensor module, and the memory module are embodied in a wearable device.

### BRIEF DESCRIPTION OF THE DRAWINGS

The present disclosure, in accordance with one or more various embodiments, is described in detail with reference to the following figures.

FIG. 1 illustrates a cross-sectional view of an example wristband and electronic modules of an example activity monitoring device.

FIG. 2 illustrates a perspective view of the example activity monitoring device.

FIG. 3 illustrates a cross-sectional view of the example assembled activity monitoring device.

FIG. 4 illustrates a side view of an example electronic capsule.

FIG. 5 illustrates a cross-sectional view of the example electronic capsule.

FIG. 6 illustrates perspective views of example wristbands according to various embodiments of the disclosure.

FIG. 7 illustrates an example system for creating a dynamic user activity profile.

FIG. 8 illustrates an example apparatus for creating a dynamic user activity profile.

FIG. 9 illustrates another example apparatus for creating a dynamic user activity profile.

FIG. 10 is an operation flow diagram illustrating an example method for creating a dynamic user activity profile.

FIG. 11 is an operational flow diagram illustrating another example method for creating a dynamic user activity profile.

FIG. 12 illustrates an example computing module that may be used to implement various features of the systems and methods disclosed herein.

The figures are provided for purposes of illustration only and merely depict typical or example embodiments of the disclosure. The figures are described in greater detail in the description and examples below, and are not intended to be exhaustive or to limit the disclosure to the precise form disclosed. It should be understood that the disclosure may be practiced with modification or alteration, and that the disclosure may be limited only by the claims and the equivalents thereof.

### DETAILED DESCRIPTION

The present disclosure is directed to various embodiments of systems and methods for creating a dynamic user activity profile. The details of some example embodiments of the systems, methods, and apparatus of the present disclosure are set forth in the description below. Other features, objects, and advantages of the disclosure will be apparent to one of skill in the art upon examination of the present description, figures, examples, and claims. It is intended that all such additional systems, methods, features, and advantages, etc., be included within this description, be within the scope of the present disclosure, and be protected by one or more of the accompanying claims.

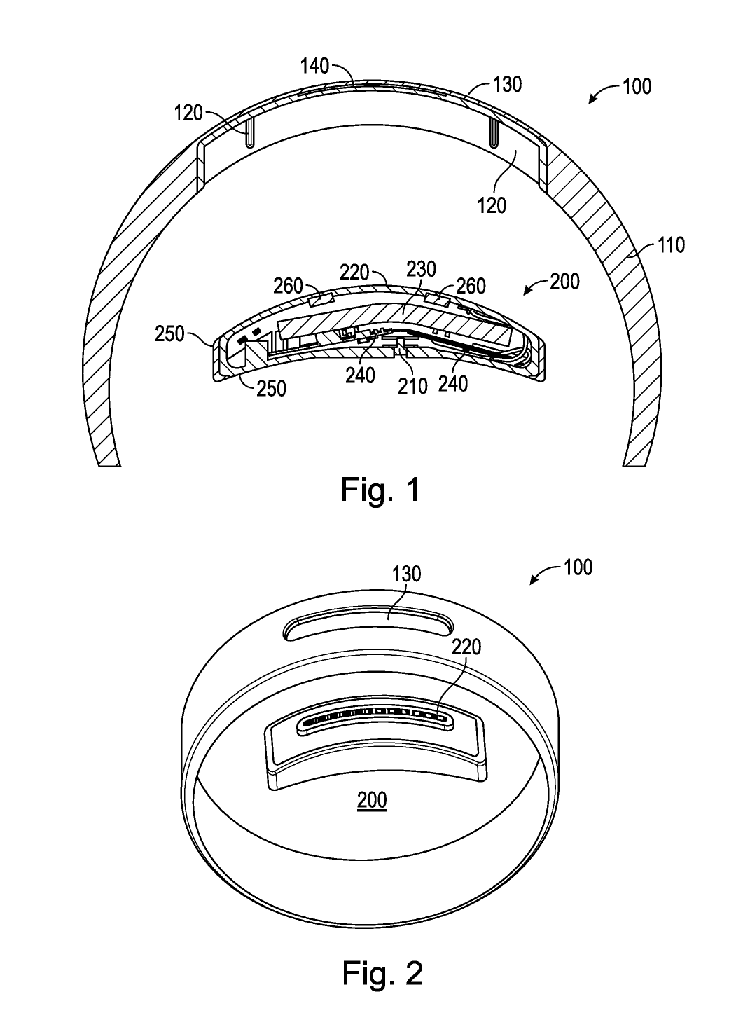

Various embodiments of the disclosed systems, methods, and apparatus for creating a dynamic user activity profile are implemented in conjunction with a wearable device, configured to be convenient for on-the-go applications and to capture a user's activity in such applications, as well as in other applications. In some example implementations, an electronic capsule may be embedded in and removable from such a device that is attachable to the user—for example, the attachable device may be in the form of a wristband, and/or may include an activity monitoring device or module. Because such an attachable device provides context for the disclosed systems and methods for creating a dynamic user activity profile, various examples of the device will be described with reference to FIGS. 1 through 6. It should also be noted, however, that the disclosed systems, methods, and apparatus may be implemented using any mobile or handheld device (e.g., smartphone), whether or not such mobile device is wearable or attachable to a user.

FIG. 1 is a diagram illustrating a cross-sectional view of an embodiment of a wearable activity monitoring device that includes wristband 100 and electronic capsule 200, which further includes wrist biosensor 210, finger biosensor 220, battery 230, one or more logic circuits 240, and casing 250. In some embodiments, logic circuits 240 include an accelerometer, a wireless transceiver, and additional circuitry. Logic circuits 240 may further include a gyroscope. Logic circuits 240 may be configured to process electronic input signals from biosensors 210 and 220 and from the accelerometer, to store the processed signals as data, and to communicate the data using the wireless transceiver. The transceiver may be configured to communicate using various available wireless communications standards—for example, Bluetooth, Wi-Fi, GPS, cellular, or some combination thereof. The transceiver may further include a wired interface (e.g. USB, fiber optic, HDMI, etc.) for communicating stored data and for receiving data as well.

Logic circuits 240 are electrically coupled to wrist biosensor 210 and finger biosensor 220. In addition, logic circuits 240 are configured to receive and process a plurality of electronic signals from each of wrist biosensor 210 and finger biosensor 220. In one embodiment, the plurality of signals includes an activation time signal and a recovery time signal, such that logic circuits 240 may process the plurality of signals to calculate an activation recovery interval equal to the difference between the activation time signal and the recovery time signal. The plurality of signals, in another example implementation, includes electro-cardio signals from a user's heart, and logic circuits 240 process the electro-cardio signals to calculate and store an RR-interval. The RR-interval may, for example, be equal to the delta in time between two R-waves, where the R-waves are the electro-cardio signals generated by a ventricle contraction in the heart. The RR-interval may then be used to calculate and store a heart rate variability (HRV) value. In various embodiments, finger biosensor 220 and wrist biosensor 210 are replaced or supplemented by a single biosensor, for example, an optical biosensor, such as a pulse oximeter, configured to detect blood oxygen saturation levels. The pulse oximeter may then output a signal to logic circuits 240 indicating a detected cardiac cycle phase, and logic circuits 240 may use cardiac cycle phase data to calculate an HRV value.

Logic circuits 240 may further detect and store metrics such as the amount and/or type of a user's physical activity, sleep, rest, and the like, over a recent period of time, or the amount of time without physical activity over a recent period of time. Logic circuits 240 may then use the HRV, or the HRV in combination with one or more of the above-described metrics, to calculate a fatigue level for the user. By way of illustration, logic circuits 240 may detect the amount of physical activity and the amount of sleep the user experienced over the last 48 hours, combine those metrics with the user's HRV, and calculate a fatigue level of between 1 and 10 (or on any scale), and the fatigue level may indicate the user's physical condition and aptitude for further physical activity that day or in general.

Wristband 100 includes material 110 configured to encircle a human wrist, and may be adjustable. Cavity 120 is notched on the radially inward facing side of the wristband and shaped to substantially the same dimensions as the profile of electronic capsule 200. In addition, aperture 130 is located in material 110 within cavity 120. Aperture 130 is shaped to substantially the same dimensions as the profile of finger biosensor 220. The combination of cavity 120 and aperture 130 is designed to detachably couple to electronic capsule 200 such that, when electronic capsule 200 is positioned inside cavity 120, finger biosensor 220 protrudes through aperture 130. Electronic capsule 200 may further include one or more magnets 260 configured to secure electronic capsule 200 to cavity 120. Magnets 260 may be concealed in casing 250. Alternatively, cavity 120 may be configured to conceal magnets 260 when electronic capsule 200 detachably couples to the combination of cavity 120 and aperture 130. Wristband 100 may further comprise steel strip 140 concealed in material 110 within cavity 120. In one embodiment, when electronic capsule 200 is positioned within cavity 120, one or more magnets 260 are attracted to steel strip 140 and pull electronic capsule 200 radially outward with respect to wristband 100. The force provided by magnets 260 may detachably secure electronic capsule 200 inside cavity 120. In alternative embodiments, electronic capsule 200 is positioned inside the wristband cavity and affixed using a form-fit, press-fit, snap-fit, friction-fit, VELCRO, or other temporary adhesion or attachment technology.

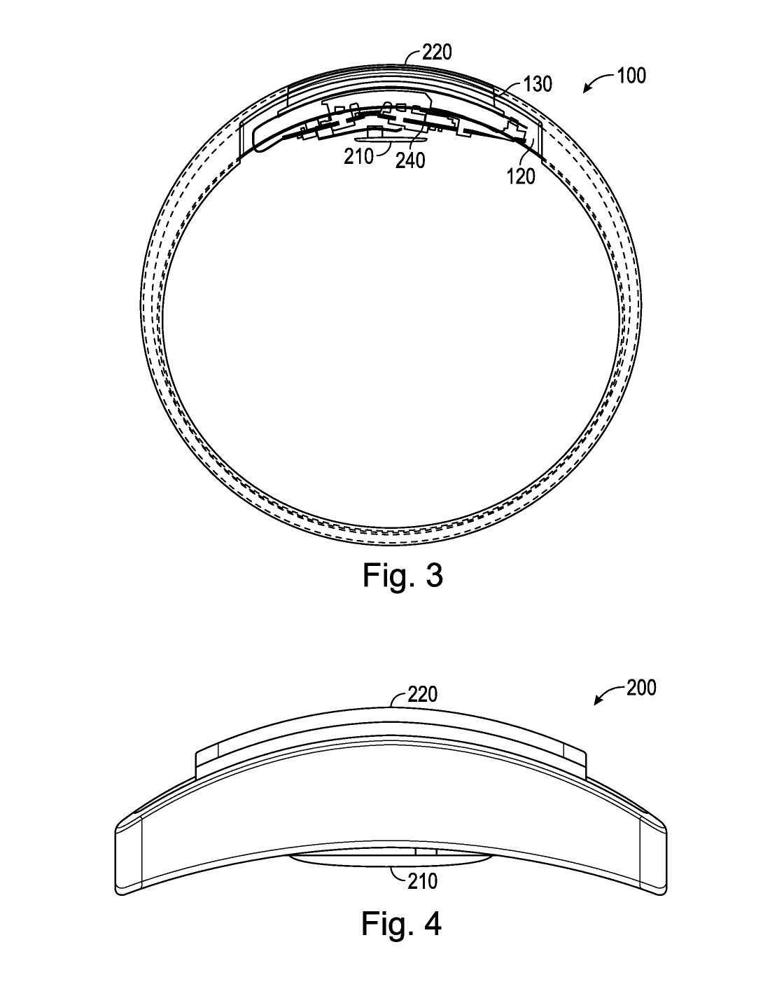

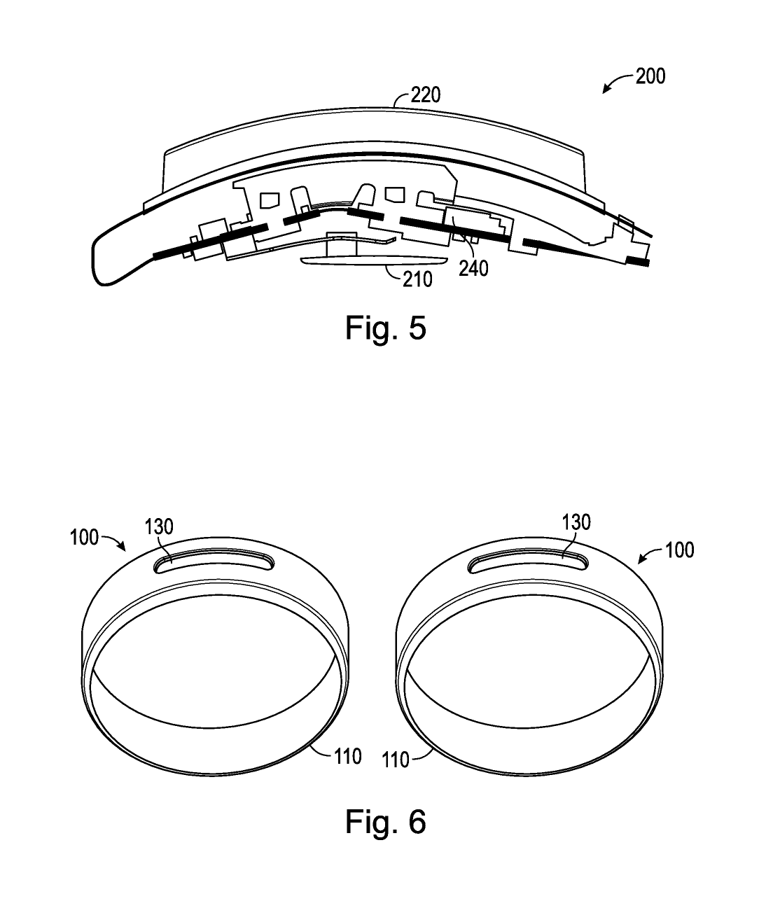

FIG. 2 illustrates a perspective view of one embodiment of the disclosed wearable activity monitoring device, in which wristband 100 and electronic capsule 200 are unassembled. FIG. 3 illustrates a cross-sectional view of one embodiment of fully assembled wristband 100 with a removable monitoring device. FIG. 4 illustrates a side view of an electronic capsule 200, according to one embodiment of the disclosure. FIG. 5 illustrates a cross-sectional view of electronic capsule 200. FIG. 6 is a perspective view of two variants of wristband 100, according to various embodiments of the disclosure.

Electronic capsule 200 may be attached anywhere on a user's body or in the user's vicinity by way of, for example, an attachable strap or band (e.g., by being attached to the user's bicycle). In one embodiment of the disclosure, electronic capsule 200 further includes an optical sensor such as a heart rate sensor or oximeter. The optical sensor may be positioned to face radially inward towards a human wrist when wristband 100 is fit on the human wrist. The optical sensor may be separate from electronic capsule 200, but still detachably coupled to wristband 100 and electrically coupled to the circuit boards enclosed in electronic capsule 200. Wristband 100 and electronic capsule 200 may operate in conjunction with or may house or include a system for creating a dynamic user activity profile. Considering the above context regarding wearable/mobile devices that may be used to implement various embodiments of the disclosure, systems and methods for creating a dynamic user activity profile will now be described.

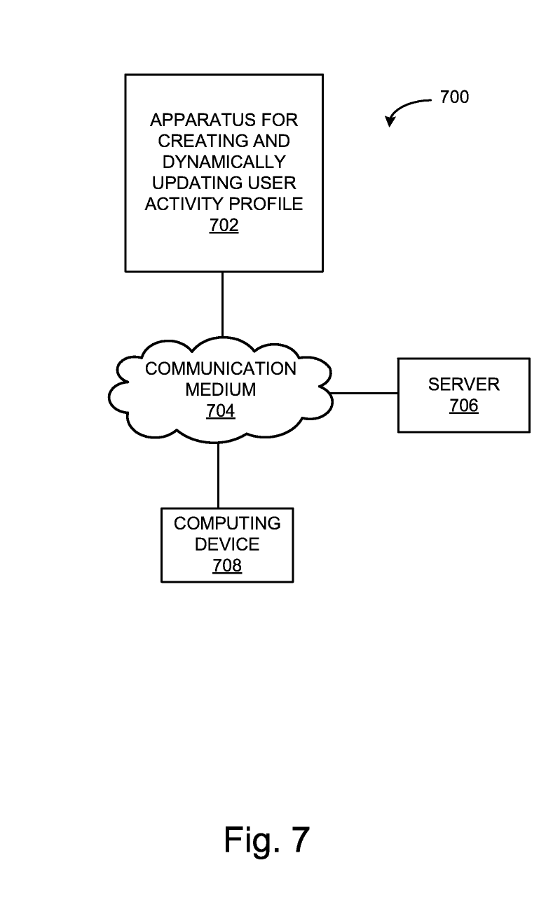

FIG. 7 is a schematic block diagram illustrating an example implementation of system 700 for creating a dynamic user activity profile. System 700 includes apparatus 702 for creating and dynamically updating a user activity profile, communication medium 704, server 706, and computing device 708. Embodiments of system 700 are capable of capturing and tracking robust information related to a user's activity, including information about the user's activity type, duration, intensity, and so on. Moreover, embodiments of system 700 create and dynamically update a user activity profile based on the captured and tracked user activity information. This dynamically updated user activity profile allows system 700, in various embodiments, to provide user-specific recommendations regarding activity, including target goals and the like. Being user-specific and dynamic, the recommendations provided by system 700 may be personalized, so as to push the user to progress, while also being based on the user's actual activity, including up-to-date trends and statistics related thereto, thus being realistically achievable by the user. Such personalized, yet realistic goals may be more effective in terms of driving the user's progress than, for example, overly aggressive goals that may be discouraging or may result in injury, or goals that are not sufficiently aggressive to push the user's limits.

Referring again to FIG. 7, communication medium 704 may be used to connect or communicatively couple apparatus 702, server 706, and/or computing device 708 to one another or to a network, and communication medium 704 may be implemented in a variety of forms. For example, communication medium 704 may include an Internet connection, such as a local area network (“LAN”), a wide area network (“WAN”), a fiber optic network, internet over power lines, a hard-wired connection (e.g., a bus), and the like, or any other kind of network connection. Communication medium 704 may be implemented using any combination of routers, cables, modems, switches, fiber optics, wires, radio (e.g., microwave/RF links), and the like. Communication medium 704 may be implemented using various wireless standards, such as Bluetooth®, Wi-Fi, 3GPP standards (e.g., 4G LTE), etc. Upon reading the present disclosure, one of skill in the art will recognize other ways to implement communication medium 704 for communications purposes.

Server 706 directs communications made over communication medium 704. Server 706 may include, for example, an Internet server, a router, a desktop or laptop computer, a smartphone, a tablet, a processor, a module, or the like, and may be implemented in various forms, include, for example, an integrated circuit, a printed circuit board, or in a discrete housing/package. In one embodiment, server 706 directs communications between communication medium 704 and computing device 708. For example, server 706 may update information stored on computing device 708, or server 706 may send/receive information to/from computing device 708 in real time.

Computing device 708 may take a variety of forms, such as a desktop or laptop computer, a smartphone, a tablet, a smartwatch or other wearable electronic device, a processor, a module, or the like. By way of illustration, computing device 708 may be a processor or module embedded in a wearable sensor, a bracelet, a smart-watch, a piece of clothing, an accessory, and so on. Computing device 708 may be, for example, substantially similar to devices embedded in electronic capsule 200, which may be embedded in and/or removable from wristband 100, as illustrated in FIG. 1 and described hereinabove. Computing device 708 may communicate with other devices over communication medium 704 with or without the use of server 706. In one embodiment, computing device 708 includes apparatus 702 for creating and dynamically updating a user activity profile. In various embodiments, apparatus 702 may be used to perform various processes described herein and/or may be used to execute various operations described herein with regard to one or more disclosed systems and methods. Upon studying the present disclosure, one of skill in the art will appreciate that system 700 may include multiple apparatus 702, servers 706, and/or computing devices 708, and that apparatus 702 may be embodied in or part of computing device 708.

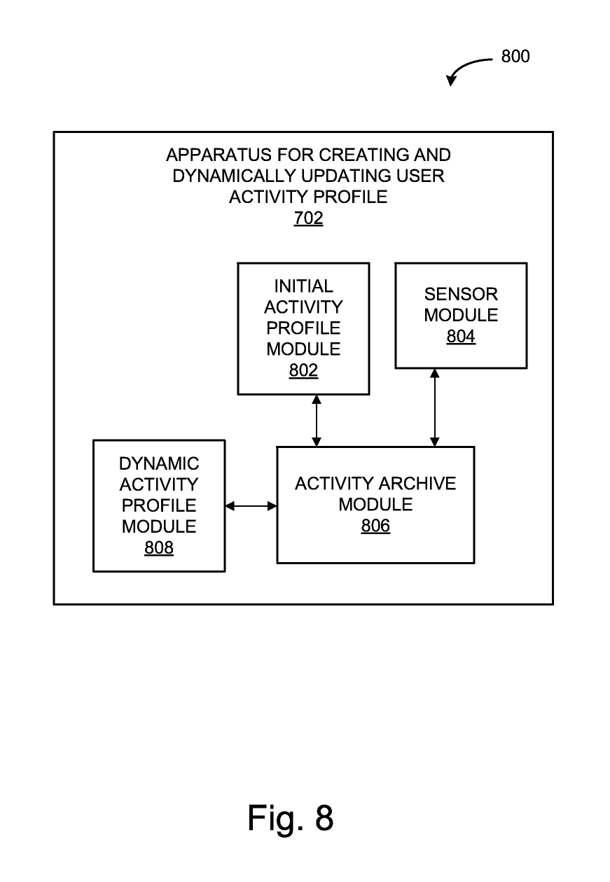

FIG. 8 is a schematic block diagram illustrating an embodiment of apparatus 800 for creating a dynamic user activity profile. As illustrated, apparatus 800 includes apparatus 702, which, in turn, includes initial activity profile module 802, sensor module 804, activity archive module 806, and dynamic activity profile module 808. In various implementations of the disclosure, apparatus 702 creates a dynamic user activity profile as follows: initial activity profile module 802 creates an activity profile for a user; sensor module 804 monitors or tracks the user's activity to generate activity information; the activity information may be fed to activity archive module 806; activity archive module 806 maintains an activity archive that includes the activity information; and dynamic activity profile module 808 updates the activity profile based on the activity archive. In this manner, the dynamic activity profile module 808, in conjunction with the other, above-mentioned modules of apparatus 702, may create/update the user activity profile to be a dynamic profile that captures up-to-date information and trends regarding the user's activity. Additional aspects and features of initial activity profile module 802, sensor module 804, activity archive module 806, and dynamic activity profile module 808, are described below in further detail with regard to various processes and/or methods disclosed herein.

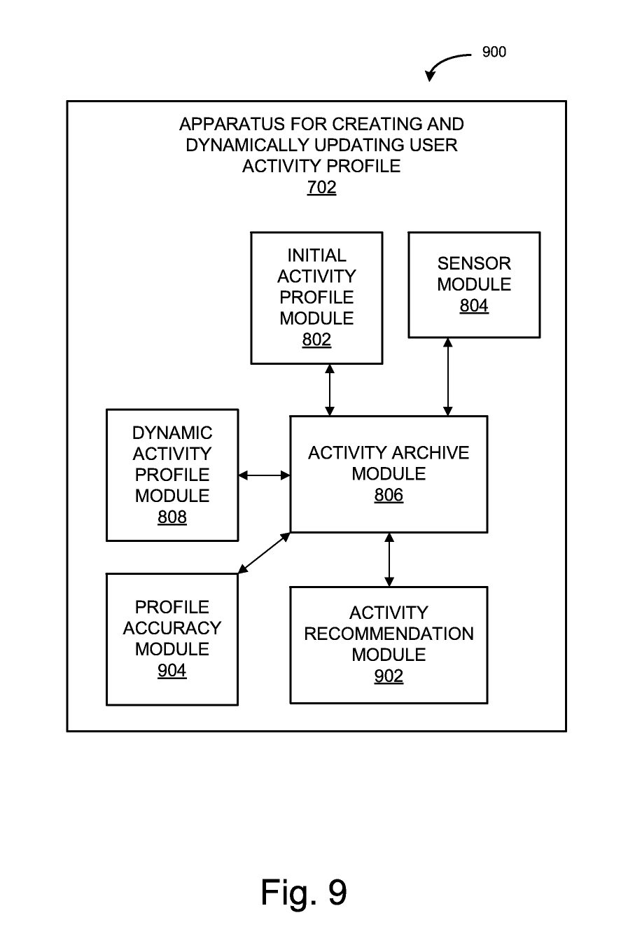

FIG. 9 is a schematic block diagram illustrating an embodiment of apparatus 900 for creating a dynamic user activity profile. As shown in FIG. 9, apparatus 900 includes apparatus 702, which, in turn, includes initial activity profile module 802, sensor module 804, activity archive module 806, and dynamic activity profile module 808. Apparatus 900 also includes activity recommendation module 902 and profile accuracy module 904. Activity recommendation module 902 provides a recommendation related to the user's activity. The recommendation is based on the activity profile that is created by initial activity profile module 802 and updated by dynamic activity profile module 808. Having dynamic input regarding the activity profile (e.g., by way of archive module 806), activity recommendation module 902 may provide a user-specific, up-to-date activity recommendation that is both personalized and realistic for the user. Profile accuracy module 904 provides an indication of an estimated level of accuracy of the activity profile created by initial activity profile module 802 and updated by dynamic activity profile module 808. The estimated level of accuracy is based on the amount and consistency of activity information in the activity archive maintained by activity archive module 806. Additional aspects and features of activity recommendation module 902 and profile accuracy module 904 are described below in further detail with regard to various processes and/or methods disclosed herein.

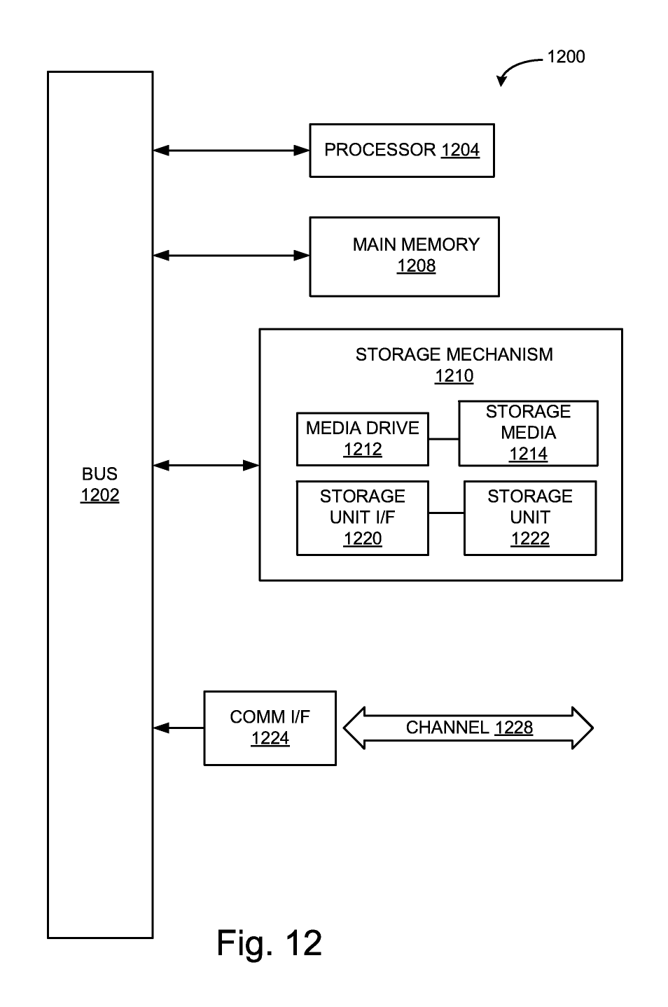

In various embodiments of the disclosure, one or more of initial activity profile module 802, sensor module 804, activity archive module 806, dynamic activity profile module 808, activity recommendation module 902, and profile accuracy module 904, is embodied in a wearable device, such as, for example, wristband 100 and/or electronic capsule 200. Moreover, any of the modules described herein may be embodied in wristband 100, electronic capsule 200, other wearable devices, or other hardware/devices (e.g., mobile devices), as will be appreciated by one of skill in the art after reading the present disclosure. Furthermore, any of the modules described herein may connect and/or communicatively couple to other modules described herein via communication medium 704. Example structures of these modules will be described in further detail hereinbelow with regard to FIG. 12.

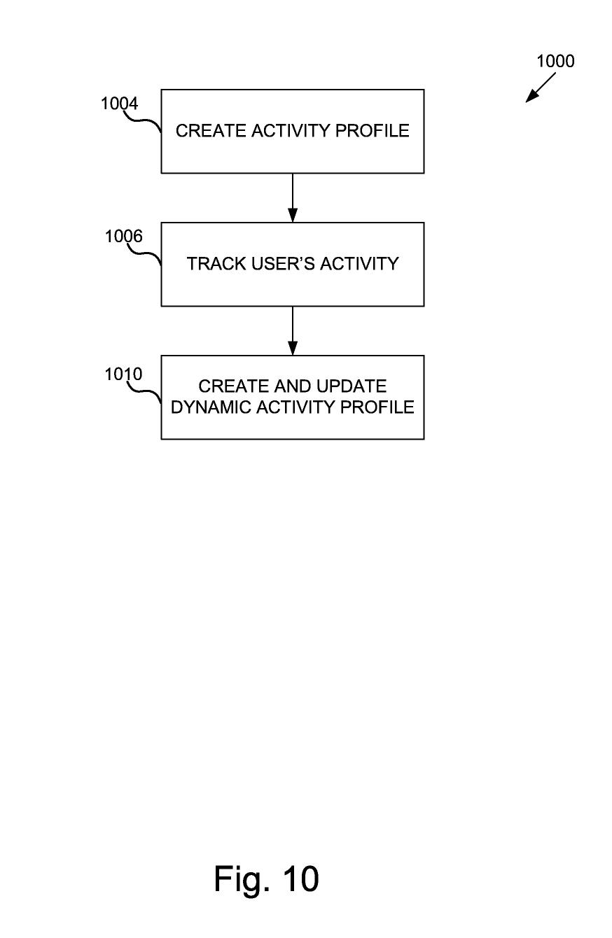

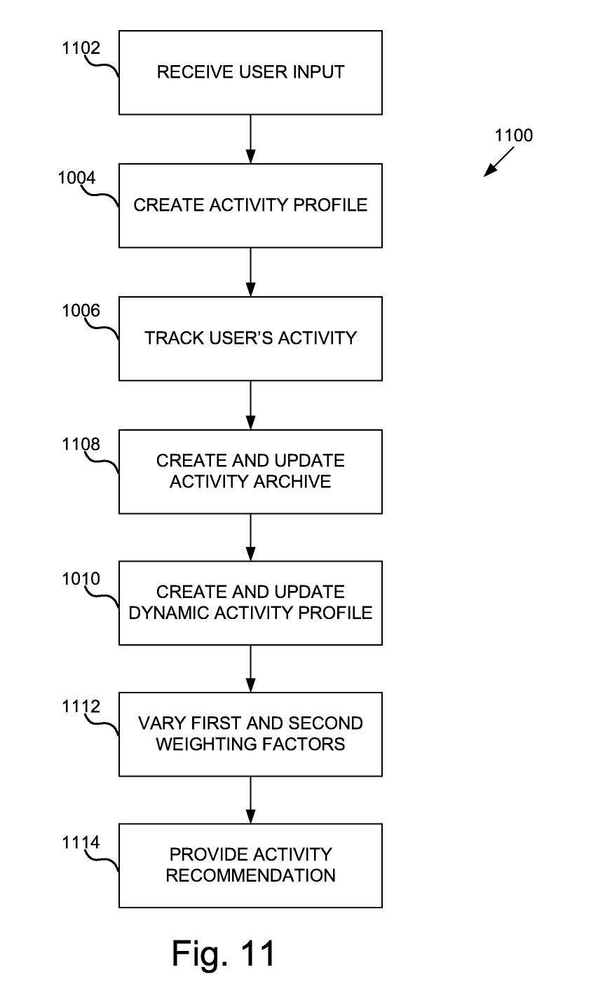

FIGS. 10 and 11 contain operational flow diagrams illustrating example embodiments of methods 1000 and 1100, respectively, for creating a dynamic user activity profile, in accordance with the present disclosure. The operations of methods 1000 and 1100 create and update a dynamic activity profile that is based on robust tracking of user activity and that may take into account and analyze up-to-date trends and patterns related to user activity. For example, the operations of methods 1000 and 1100 may account for patterns of activity and recovery to simulate learning the capabilities and tendencies of a user. As such, methods 1000 and/or 1100 may include providing recommendations of goals for activity levels/types that are highly tailored to the user's specific characteristics, and that are personalized, yet realistic for the user. In example implementations of methods 1000 and 1100, apparatus 702, wristband 100, electronic capsule 200, and/or one or more subcomponents/modules thereof, perform various operations of methods 1000 and/or 1100, which operations are described in further detail below.

Referring to FIGS. 10 and 11, at operation 1004, methods 1000 and 1100 involve creating an activity profile for a user. Operation 1004 may be performed as an initial matter, for example, before any user activity is tracked and before a dynamic user activity profile is created (e.g., according to operations described subsequently). By way of illustration, one embodiment of method 1100 entails receiving user input to an activity questionnaire—e.g., at operation 1102, depicted FIG. 11. In such an embodiment, the activity profile created at operation 1004 is based on the user input to the activity questionnaire. Additionally, the user input may be solicited by other means that will become apparent to one of skill in the art upon reading the present disclosure.

The activity questionnaire may be designed to facilitate the user and/or prompt user input information regarding the user, with specific regard to information about the user's activities and lifestyle tendencies. This may entail the user inputting information about the user's physical profile (e.g., height, weight, age, gender, etc.), information about the user's sleep habits (e.g., average number of hours per night, and the like), information about the user's activity levels and/or lifestyle (e.g., very active, moderately active, sedentary, etc.), and information about the user's activity aspirations (e.g., train for a race, lose weight, maintain current condition, and so on).

The activity questionnaire may be implemented, in some embodiments, using a graphical user interface (GUI), drop-down menus, and so one—for example, on a computing device, smartphone, or wearable electronic device. The user may also select various preferred or actual activity types, intensities, durations, and may input additional information, for example, information regarding past/current injuries, the user's schedule, training partners, music/media preferences for workouts or other activities, and the like. This type of user information may aid in tailoring the types of activities recommended for the user in accordance with various embodiments of methods 1000 and 1100. In some instances, operation 1002 may be performed by a module and/or computing device that is separate from but connected to apparatus 702. By way of illustration, the questionnaire and related GUI may be presented to the user on a smartphone display screen, while apparatus 702 may reside in a wearable device (e.g., wristband 100).

In various embodiments of methods 1000 and 1100, creating the activity profile (operation 1004) includes modifying the user input according to normative statistical data. The modification may depend on the type of user input received, but generally is used to determine a range of activity attributes that are typical for individuals similar to the user. For example, if the user input includes the user's age, but does not include information on the user's typical or desired activity level, the normative statistical data may be used to create an activity profile that reflects the typical activity level for a person of the user's age. The normative statistical data may be based on averages and/or other weighted data collected from statistically significant groups of individuals, and may, in some instances, be based on publicly available information. Other illustrative examples of normative statistical data that may be used to modify the user input include age-related data, physiological data, sleep data, and the like. Being based on normative data in combination with varying amounts of user-input data (e.g., ranging from minimal to extensive based on the how the user decides to populate the questionnaire), the activity profile as initially created may be somewhat tailored to the user, though not based on actually tracked/measured user activity information. As such, the modified user input may provide a useful baseline upon which the dynamic activity profile may be built, according to subsequent operations of methods 1000 and 1100. Operation 1004, in various example implementations, is performed by initial activity profile module 802.

At operation 1006, methods 1000 and 1100 involve tracking the user's activity. Tracking the user's activity may entail monitoring the user's movement (e.g., using a wearable device), to determine, for example, an activity type, intensity, duration, and so on. In some cases, operation 1006 is accomplished using a sensor configured to be attached to a user's body (e.g., by way of a wearable device). Such a sensor may include a gyroscope or accelerometer to detect movement, and a heart-rate sensor, each of which may be embedded in a wristband that a user can wear on the user's wrist or ankle, such as wristband 100. Various embodiments of operation 1006 may entail using sensor module 804.

By way of illustration, the activity type may be selected from typical activities, such as running, walking, sleeping, swimming, bicycling, skiing, surfing, resting, working, and so on. The activity intensity may be represented on a numeric scale. For example, the activity intensity may include a number ranging from one to ten (representing increasing activity intensity). And the activity intensity may be associated with the vigorousness of an activity. In other embodiments, the activity intensity may be represented by ranges of heart rates and/or breathing rates, which may also be determined as part of tracking the user's activity.

In this regard, tracking the user's activity includes, in some instances of the disclosed methods 1000 and 1100 for creating a dynamic user profile, determining an activity level of the user, which may further entail capturing and/or compiling data regarding the user's fatigue/recovery levels (e.g., as described above in reference to FIG. 1). Moreover, in additional embodiments, tracking the user's activity includes tracking a set of activity parameters. The set of activity parameters may include, for example, HRV (and/or fatigue/recovery level), sleep duration, sleep quality, subjective feedback from the user (e.g., how the user feels after a certain activity), previous user activity levels, and training load data/models). To expound, training load models may be loaded to provide comparison bases for the user's activity level, as tracked according to operation 1006, for example. Training load models may include ideal or otherwise previously determined progress/training milestones that a user may be advised to accomplish to achieve an end-goal, such as to be ready for a race, or the like.

As described, fatigue level is one example of an activity parameter that may be tracked as part of tracking the user's activity level at operation 1006. The fatigue level may be a function of recovery and/or may be described in terms of recovery (e.g., as described above in reference to FIG. 1). Further, the fatigue level may be detected using various techniques. For example, the fatigue level may be detected by measuring the user's HRV (e.g., using logic circuits 240, at detailed above in reference to FIG. 1). When HRV is more consistent (i.e., steady, consistent amount of time between heartbeats), the fatigue level may be higher. In other words, the body may be less fresh and not well rested. By contrast, when HRV is more sporadic (i.e., amount of time between heartbeats varies largely), the fatigue level may be lower. In various embodiments, the fatigue level is described in terms of an HRV or HRV score.

In various implementations, at operation 1006, HRV may be measured/determined in a number of ways (also discussed above in reference to FIG. 1). In one example embodiment, HRV is determined using the combination of wrist biosensor 210 and finger biosensor 220. Wrist biosensor 210 may, for example, measure the heartbeat in the wrist of one arm while finger biosensor 220 measures the heartbeat in a finger of the hand of the other arm. This combination allows the sensors, which in one embodiment may be conductive, to measure an electrical potential through the body. Information about the electrical potential provides cardiac information (e.g., HRV, fatigue level, heart rate information, and so on) and such information may be processed, analyzed, and/or tracked in accordance with tracking the user's activity level in methods 1000 and 1100. In other instances, HRV is determined using sensors that monitor other parts of the user's body, rather than the finger and wrist. For example, the sensor may monitor the ankle, leg, arm, and/or torso.

Fatigue level may be detected, in some cases, based solely on the HRV measured. Additionally, fatigue level may be based at least partially on other measurements or aspects of the user's activity level that may be tracked at operation 1006. For example, fatigue level may be based on the amount of sleep that is measured for the previous night, the duration and/or type of user activity, and the intensity of the activity determined for a previous time period (e.g., exercise activity level in the last twenty-four hours). By further way of illustration, addition factors that may affect fatigue level (though not necessarily HRV) include potentially stress-inducing activities such as work and driving in traffic. Such activities may cause a user to become fatigued. The fatigue level may also be determined by comparing the user's measured HRV to a reference HRV, which reference HRV may be based on information gathered from a large number of people from the general public (e.g., similar to the normative statistical data described hereinabove). In another embodiment, the reference HRV is at least partially based on past measurements of the user's HRV (and, e.g., maintained in activity archive module 806).

In additional example implementations of methods 1000 and 1100, fatigue level may be detected periodically (e.g., once every twenty-four hours). This may provide information about the user's fatigue level each day so that the user's activity levels may be tracked precisely. However, the fatigue level may be detected more or less often, as desired by the user (e.g., depending on how accurate/precise the user would like the dynamic activity profile to be) and depending on the specific application/user lifestyle.

Referring now to FIG. 11, one embodiment of method 1100 involves, at operation 1108, creating and updating an activity archive based on the user's activity (e.g., as tracked at operation 1006). The activity archive may include one more memory and/or computing modules or subcomponents thereof, as described in further detail with regard to FIG. 12. As such, the activity archive may store activity information, for example, regarding the user's activity tracked at operation 1006. Activity information may be associated with the user's tracked activity (e.g., such information may be gathered using sensor module 804), including activity type, intensity, duration, and interrelationships thereof (e.g., duration of an activity type at a particular intensity); fatigue level (e.g., including HRV and related data); sleep data; subjective user input; information related to a training load model (including parameters relevant thereto); information related to extern conditions (e.g., weather, altitude, geolocation, time of day, light conditions, etc.); and other information related to internal conditions (e.g., body temperature, cardiac information, breathing, and the like). The activity archive may thus, in some embodiments, act as a source and/or an analysis engine of robust information to generate metrics useful to create personalized, yet realistic combinations of activity types, activity intensities, activity durations, fatigue levels, rest patterns, and so on. Moreover, the activity archive may include other historical information regarding user activity, such as historical information about the user's activity (e.g., information monitored by sensor module 804).

At operation 1010, methods 1000 and 1100 include creating and updating a dynamic activity profile based on the activity profile (created at operation 1004) and the user's activity (e.g., as tracked at operation 1006). The dynamic activity profile may include multiple activity profile data points (or activity parameters) that include, by way of illustration, the activity parameters. For example, the dynamic activity profile may include the user's activity level (e.g., activity type, intensity, and duration), sleep levels (e.g., sleep duration, quality, patterns, etc.), fatigue levels (e.g., including HRV), ongoing subjective feedback from the user, and so on. In one embodiment, the dynamic activity profile is based on one or more statistically manipulated activity parameters that make up at least some of the dynamic activity profile data points. In such an example, creating and updating the dynamic activity profile may entail calculating and maintaining daily averages for any of the above-described activity parameters (e.g., average daily sleep duration). Moreover, a range of high and low values, median values, skew (e.g., shape of distribution of values, including standard deviation, correlations and other statistical relationships between data points, and so on) for each of the activity parameters/data points may also be maintained and incorporated into the dynamic activity profile.

The dynamic activity profile may be created as an initial matter, for example, based on stock or default data or user input and/or after the user activity profile is created (see, e.g., operations 1102 and 1004), but such a profile may be less precise/accurate than if the profile were based on actual, tracked user activity. As such, operation 1010 may involve updating the dynamic activity profile periodically as user activity is tracked (e.g., at operation 1006). In various embodiments, the period for updating the dynamic activity profile may be: (a) selected by the user; (b) default to a stock value (e.g., once daily); (c) set to vary based on changes in the user's activity (e.g., update based on a predetermined amount of variation, as captured in the activity archive); or (d) set to vary based on one or more trigger events (e.g., when HRV is measured, when the user wakes up, etc.). Additionally, the dynamic activity profile may be updated on-the-fly.

One example implementation of the dynamic activity profile includes a matrix stored/maintained in the activity archive (which, by way of example, may be implemented using a memory module). In such an example, the matrix includes one or more data points, cells, etc., each corresponding or associated with an activity parameter. The dynamic activity profile may be accessible to the user, for example, by way of a GUI; may be exportable (e.g., in the form of a .csv file); or may be shared with other users (e.g., via communication medium 704). Furthermore, the dynamic activity profile may be represented graphically, including, by way of illustration, past or projected changes in the dynamic activity profile and/or regarding one or more of the activity parameter values.

In one implementation of the disclosure, the user may be able to manipulate or tune the activity parameters to view/analyze the corresponding effect on the dynamic activity profile. In other words, this aspect of the disclosed systems and methods for creating a dynamic user activity profile may allow a user to view, based on patterns and learned tendencies regarding the user's activity, how changes that the user may make in the user's activity/lifestyle may affect the user going forward. This may provide the user with increased motivation to pursue changes, and may give the user a better understanding of how aggressive the user wants or needs to be to achieve the user's lifestyle goals (e.g., to obtain a desired or planned fitness level). The user may also, for example, view past evolutions of the dynamic activity profile—that is, the user may view freeze-frames of the dynamic activity profile as the dynamic activity profile existed in past time periods, and may call up various activity parameters as tracked during those time period.

As described above, the dynamic activity profile is based on the activity profile and the user's activity. In various embodiments of methods 1000 and 1100, the activity profile contributes to the dynamic activity profile according to a first weighting factor, and the user's activity contributes to the dynamic activity profile according to a second weighting factor. To illustrate, and as described above, the dynamic activity profile may be stored/maintained as a matrix of values. And the values may be categorized according to types of activity parameters (or, for example, types of data points tracked at operation 1006 or calculated thereafter). Further, the values in the dynamic activity profile may include a component attributable to the user input received initially (e.g., at operation 1102) and a component attributable to the activity tracked (or a statistically manipulated version of such tracked activity data point/component). The first weighting factor may be a numerical multiplier that is applied to the user-input component (i.e., the activity profile) and the second weighting factor may be a numerical multiplier that is applied to the tracked-activity component (i.e., the user's activity).

Referring now to FIG. 11, one embodiment of method 1100 includes, at operation 1112, varying the first and second weighting factors. For example, operation 1112 may involve decreasing the first weighting factor as information about the user's activity is tracked and stored in the activity archive. Continuing the example, operation 1112 may further involve increasing the second weighting factor as information about the user's activity is tracked and stored in the activity archive. Varying the first and second weighting factors may, by way of example, increase the accuracy of the dynamic activity profile as more activity information is gathered and as the user's activity tendencies are better learned. The activity profile for the user (e.g., created at operation 1004) is generally based on the user's self-evaluated activity/personal information (e.g., as gathered by the questionnaire described above). Moreover, even when this self-evaluated information is modified according to normative statistical data, the activity profile is still typically a rougher estimate. By contrast, the user's activity (e.g., as represented in the activity archive), may be up-to-date, and the activity archive may analyze patterns and/or tracked tendencies. Therefore, the user's activity may be more tailored to the user, and may be more precise/accurate. More heavily weighting the contribution of the user's activity to the dynamic activity profile may provide the user with better insight into the user's performance, and may better enable the user to set personalized, yet realistic goals and expectations.

In some instances, the first and second weighting factors may be varied to discount the contribution of selected portions of the user activity to the dynamic activity profile. Some portions (e.g., over a period of time, or a particular activity type) may be anomalous in terms of the user's actual activity—as such, incorporating these portions into the dynamic activity profile may decrease the accuracy thereof. By way of illustration, if the user gets sick and needs to rest, the user may refrain from exercise for a time. In instances where such an anomaly represents a departure from the user's normal life, this may be sensed based on the information in the activity archive, and discounted accordingly to avoid spurious results corrupting the dynamic activity profile. Such discounting may, for example, increase the accuracy/legitimacy of the dynamic activity profile, and may also decrease the likelihood that irregularities unrepresentative of the user's lifestyle are incorporated into the dynamic activity profile. As an example, the first and second weighting factors may range from 0 to 1 (e.g., may be decimal/fraction values), and may be complementary, such that the first and second weighting factors add up to 1.

Regarding the accuracy of the dynamic activity profile, one embodiment of method 1100 includes indicating an estimated level of accuracy for the dynamic activity profile. In such an embodiment, the estimated level of accuracy is based on an amount and a consistency of the activity information (e.g., stored/maintained by the activity archive). In typical cases, the accuracy of the dynamic activity profile increases as more and more activity information is captured (e.g., through tracking the user's activity). Further, the accuracy of the dynamic activity profile also typically increases as the activity information captured is consistent. In other words, if there are significant anomalies and otherwise outlying data tracked, this may decrease the accuracy of the dynamic activity profile (in terms of representing the user's typical tendencies). By way of example, the estimated level of accuracy may be represented as a numerical score, as a textual description, graphically, audibly, and so on, and may be provided to the user concurrently with or separately from the dynamic activity profile. In one example implementation, each activity parameter in the dynamic activity profile may be associated with an estimated level of accuracy, depending on how much and/or how consistent the dataset associated with that parameter is.

At operation 1114, one embodiment of method 1100 includes providing an activity recommendation based on one or more of the activity parameters (e.g., as described above with regard to operation 1010). In some instances, the activity recommendation is an early-stage recommendation based on the activity profile (e.g., created at operation 1004, before user activity is tracked). Such an early-stage activity recommendation may be personalized to the extent the same is based on user input (e.g., via the questionnaire) and normative data that approximates the user's activity/tendencies. However, in other instances, the activity recommendation is provided based on tracked activity parameters, and is further based on the dynamic activity profile.

Examples of recommendations for user activity may include activity level (e.g., in terms of type, intensity, and/or duration of activity, and the like), user reaction to activity (e.g., subjective input from user, heart rate, HRV, breathing, etc.), sleep activity (e.g., duration, timing of sleep, conditions/routine related to sleep, etc.), and the like. In a further example, the activity recommendation may be based on a training load model—e.g., to prepare the user to meet a goal, prepare for a race/event, etc., as specified in the model. To expound, the activity recommendation may be based on a training regimen to achieve training goals, for example, to prepare the user for the marathon or other upcoming event. In this example, the activity recommendation may require the user to run a long distance on particular days, and/or to run at a particular pace (or intensity/heart rate) on certain days. In any case, being based (at least in part) on the dynamic activity profile and/or the underlying activity parameters, these activity recommendations may be more personalized/specific to the user, thus being more likely to push the envelope in terms of being both personalized and realistically achievable for the particular user.

By way of further illustration, one embodiment of method 1100 includes recommending an activity level based on the user's past activity, including historical information about user activity type and user activity intensity, duration, and the user's past fatigue levels (associated with past measuring periods, for example). As such, operation 1114 may provide a recommended goal for activity level that is specific to the user's patterns of activity and fatigue, as well as to the user's current level of fatigue (e.g., as determined based on an HRV measurement and/or other factors).

Moreover, when the dynamic activity profile includes contributions from normative data (e.g., based on operation 1004), the recommended activity level may be based on the normative data in addition to the historical data on activity and fatigue. For example, if a fatigue level that is higher than typical (compared to the archive's historical fatigue levels for the user) is detected, operation 1114 may entail recommending an activity level that is lower than typical for the user. In some example implementations, this by done by way of creating a fatigue multiplier. The fatigue multiplier may include, for example, a ratio of the current fatigue level to average historical fatigue level (e.g., as captured in the dynamic activity profile). By contrast, if the fatigue level is lower than typical, operation 1114 may entail recommending an activity level that is higher than typical. In other instances, the activity level is not inversely proportional to the fatigue level—for example, the user's capacity for activity (again, reflected in, for example, the dynamic activity profile and/or the activity archive) may be greater even if the user is more fatigued. Additionally, the normative data may be used to supplement/modify the fatigue modifier, based on what is determined to be statistically typical or average for the user.

In one embodiment, the recommended activity level is based on an anticipation of a future activity, and the future activity is anticipated based on the activity archive and/or the dynamic activity profile. In such an embodiment, it is determined, e.g., from the activity archive, that the user has a higher level of activity than typical (e.g., greater user activity intensity or longer duration of activity types) for a particular day of the week relative to other days of the week. A higher activity level may be recommended for that particular day, due to the learned tendency/pattern of the user's performance. To illustrate, as the user's activity is tracked, it may be determined that the user plays soccer for two hours each Tuesday night. The recommended activity level provided at operation 1114 may be adjusted upward on Tuesdays as a result. In other words, the recommended activity level may conform to the user's desired and/or historical activity levels, having some days as more active and others as less active. In another embodiment, the recommended activity may not conform to the user's schedule if to do so would not help the user perform at the user's peak performance level.

In one case, the activity recommendation is based on an amount of sleep monitored from the previous night. For example, if at operation 1006, eight hours of sleep were tracked for the previous night, a high recommendation for activity level may be provided. This is because the user is likely relatively well rested. In another example, if operation 1006 tracks only four hours of sleep for the user, a lower recommendation for activity level may be provided. This is because the user is likely not as well rested. In another case, the activity recommendation is based on user input that specifies a targeted aggressiveness for achieving a performance goal of the user. For example, the user input may indicate that the user would like to be relatively aggressive in achieving the user's performance/fitness/lifestyle goals. In response, the activity recommendation provided at operation 1114 may include activity levels that are relatively high. This may, for example, push the user to achieve the user's performance goals more quickly.

The activity recommendation, in other instances, is based on the user's learned tendencies (e.g., through the dynamic activity profile and/or the activity archive). To illustrate, the user may tend to be more fatigued on a certain day of the week, to be more fatigued after a certain amount of sleep, or to be more fatigued after a particular level of activity. As more activity information is recorded in the activity archive, method 1100 may involve tracking (e.g., operation 1006), storing/capturing (e.g., operation 1108), and analyzing (e.g., one or more of operations 1108, 1010, 1112, and 1114) developed patterns and interrelationships between the user's activity and fatigue that allow the user's tendencies to be learned. The activity recommendation may then be based on the user's particular, learned tendencies, and may accordingly be tailored specifically for the user to be personalized, yet realistic.

Additionally, method 1100 may entail adjusting the activity recommendation based on one or more of the user's scheduled upcoming activities/events. For example, the activity recommendation may be adjusted for the days or weeks before the user is scheduled to participate in a triathlon, such that the user does not become overworked or underworked before or during the scheduled event. Moreover, in some cases the activity recommendation may be adjusted following a scheduled event. By way of illustration, if the user competes in a scheduled triathlon, the activity recommendation may be adjusted downward (e.g., less activity, more rest/sleep) following the event so that the user can rest and recover. In other instances, the user's tendencies regarding optimum blend of activity, including exercise versus rest, etc., may be learned by way of the above-described operations. In various example implementations of method 1100, operation 1114 is performed by activity recommendation module 902.

FIG. 12 illustrates an example computing module that may be used to implement various features of a system for creating and dynamically updating a user activity profile, and that may be used to implement various features of additional systems, apparatus, and methods disclosed herein. One embodiment of the computing module includes a processor, a sensor module, and a memory module. The memory module includes stored computer program code that, along with the processor and the memory module, may be configured to perform a number of operations—one embodiment is as follows. The memory module, the stored computer program code, and the processor are configured to maintain an activity archive that includes activity information. The activity information is received/captured from the sensor module and is representative of the user's activity. The memory module, the stored computer program code, and the processor are further configured to create and update a dynamic activity profile based on initial user input and further based on the activity archive. The initial user input contributes to the dynamic activity profile according to a first weighting factor, and the activity archive contributes to the dynamic profile according to a second weighting factor.

In an additional embodiment of the system for creating and dynamically updating a user activity profile, the memory module, the stored computer program code, and the processor are further configured to vary the first weighting factor based on the activity information in the activity archive, and to vary the second weighting factor based on the activity information in the activity archive. The memory module, the stored computer program code, and the processor, in another embodiment, are further configured to recommend activities for the user based on the dynamic activity profile. Moreover, in various embodiments, the processor, the sensor module, and the memory module, are embodied in a wearable device or other computing device.

In some instances, features of the above-described embodiments of the system for creating and dynamically updating a user activity profile may be substantially similar to those described above with reference to FIGS. 1 through 11 (and the accompanying systems, methods, and apparatus). The example computing module may be implemented and may be used to implement the above-described various features in a variety of ways, as described above with reference to FIGS. 1 through 11, and as will be appreciated by one of ordinary skill in the art upon reading the present disclosure.

As used herein, the term module may describe a given unit of functionality that can be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example computing module 1200. After reading this description, it will become apparent to a person skilled in the relevant art how to implement the application using other computing modules or architectures.

Referring now to FIG. 12, computing module 1200 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 1200 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 1200 may include, for example, one or more processors, controllers, control modules, or other processing devices, such as a processor 1204. Processor 1204 may be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 may also include one or more memory modules, simply referred to herein as main memory 1208. For example, preferably random access memory (RAM) or other dynamic memory, may be used for storing information and instructions to be executed by processor 1204. Main memory 1208 may also be used for storing temporary variables or other intermediate information during execution of instructions to be executed by processor 1204. Computing module 1200 may likewise include a read only memory (“ROM”) or other static storage device coupled to bus 1202 for storing static information and instructions for processor 1204.

The computing module 1200 may also include one or more various forms of information storage mechanism 1210, which may include, for example, a media drive 1212 and a storage unit interface 1220. The media drive 1212 may include a drive or other mechanism to support fixed or removable storage media 1214. For example, a hard disk drive, a solid state drive, a magnetic tape drive, an optical disk drive, a CD or DVD drive (R or RW), or other removable or fixed media drive may be provided. Accordingly, removable storage media 1214 may include, for example, a hard disk, a solid state drive, magnetic tape, cartridge, optical disk, a CD or DVD, or other fixed or removable medium that is read by, written to or accessed by media drive 1212. As these examples illustrate, removable storage media 1214 can include a computer usable storage medium having stored therein computer software or data.

In alternative embodiments, information storage mechanism 1210 may include other similar instrumentalities for allowing computer programs or other instructions or data to be loaded into computing module 1200. Such instrumentalities may include, for example, a fixed or removable storage unit 1222 and a storage unit interface 1220. Examples of fixed/removable such storage units 1222 and storage unit interfaces 1220 can include a program cartridge and cartridge interface, a removable memory (for example, a flash memory or other removable memory module) and memory slot, a PCMCIA slot and card, and other fixed or removable storage units 1222 and storage unit interfaces 1220 that allow software and data to be transferred from the storage unit 1222 to computing module 1200.

Computing module 1200 may also include a communications interface 1224. Communications interface 1224 may be used to allow software and data to be transferred between computing module 1200 and external devices. Examples of communications interface 1224 may include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 may typically be carried on signals, which can be electronic, electromagnetic (which includes optical) or other signals capable of being exchanged by a given communications interface 1224. These signals may be provided to communications interface 1224 via a channel 1228. This channel 1228 may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 1208, storage unit interface 1220, storage unit 1222, removable storage media 1214, and channel 1228. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions may enable the computing module 1200 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments.

What is claimed is:

1. An apparatus for creating and dynamically updating a user activity profile, the apparatus comprising:
an initial activity profile module that creates an activity profile for a user;
a sensor module that monitors the user's activity to generate activity information;
an activity archive module that maintains an activity archive comprising the activity information; and
a dynamic activity profile module that updates the activity profile based on the activity archive.

2. The apparatus of claim 1, further comprising an activity recommendation module that provides a recommendation related to the user's activity, wherein the recommendation is based on the activity profile.

3. The apparatus of claim 2, wherein the activity information comprises heart rate variability data.

4. The apparatus of claim 2, wherein the activity information is selected from the group consisting of activity level data, sleep data, subjective feedback data, activity level data, and training load data.

5. The apparatus of claim 1, further comprising a profile accuracy module that provides an indication of an estimated level of accuracy of the activity profile; wherein the estimated level of accuracy is based on an amount and a consistency of the activity information.

6. The apparatus of claim 1, wherein one or more of the initial activity profile module, the sensor module, the activity archive module, and the dynamic activity profile module, are embodied in a wearable device.

7. A method for creating and dynamically updating a user activity profile, the method comprising:
creating an activity profile for a user;
tracking the user's activity; and
creating and updating a dynamic activity profile based on the activity profile and the user's activity.

8. The method of claim 7, further comprising receiving user input to an activity questionnaire; wherein the activity profile is based on the user input to the activity questionnaire.

9. The method of claim 8, wherein creating the activity profile further comprises modifying the user input according to normative statistical data.

10. The method of claim 7, further comprising creating and updating an activity archive based on the user's activity.

11. The method of claim 10, wherein the activity profile contributes to the dynamic activity profile according to a first weighting factor, and wherein the user's activity contributes to the dynamic activity profile according to a second weighting factor.

12. The method of claim 11, further comprising decreasing the first weighting factor as information about the user's activity is tracked and stored in the activity archive, and increasing the second weighting factor as information about the user's activity is tracked and stored in the activity archive.

13. The method of claim 7, wherein tracking the user's activity comprises monitoring a movement of the user using a wearable device.

14. The method of claim 13, wherein tracking the user's activity comprises determining an activity level of the user; and wherein the dynamic activity profile is based on one or more of an average of the user's activity level, a range of the user's activity level, and a skew of the user's activity level.

15. The method of claim 7, wherein tracking the user's activity comprises tracking a set of activity parameters; and further comprising providing an activity recommendation based on one or more of the activity parameters.

16. The method of claim 15, wherein the set of activity parameters comprises heart rate variability, sleep duration, sleep quality, subjective feedback from the user, previous activity levels, and training load data.

17. A system for creating and dynamically updating a user activity profile, the system comprising:
a processor;
a sensor module; and
a memory module comprising stored computer program code, wherein the memory module, the stored computer program code, and the processor are configured to:
maintain an activity archive, the activity archive comprising activity information received from the sensor module and representative of a user's activity; and
create and update a dynamic activity profile based on initial user input and further based on the activity archive;
wherein the initial user input contributes to the dynamic activity profile according to a first weighting factor, and wherein the activity archive contributes to the dynamic profile according to a second weighting factor.

18. The system of claim 17, wherein the memory module, the stored computer program code, and the processor are further configured to:
vary the first weighting factor based on the activity information maintained in the activity archive; and
vary the second weighting factor based on the activity information in the activity archive.

19. The system of claim 17, wherein the memory module, the stored computer program code, and the processor are further configured to recommend activities for the user based on the dynamic activity profile.

20. The system of claim 17, wherein the processor, the sensor module, and the memory module are embodied in a wearable device.
